(19) United States
(12) Patent Application Publication
(10) Pub. No.: US 2009/0241813 A1
(43) Pub. Date: Oct. 1, 2009

(54) Combination Digging Implement and Valuables Container

(76) Inventor: Ronald E. Gray, Sequim, WA (US)

Correspondence Address: QUICKPATENTS, INC., 32861 CALLE PERFECTO, SUITE A, SAN JUAN CAPISTRANO, CA, 92675, US

(21) Appl. No.: 12/056,965

(22) Filed: Mar. 27, 2008

(51) Int. Cl. E05G 1/02; B65D 79/00

(52) U.S. Cl. 109/50; 109/23; 206/216

(57) ABSTRACT

The invention is a container for safely holding personal items of a user at the beach. The container includes a hollow shell with a pointed lower end, an aperture at a top end, and a cover. With the personal items inserted into the hollow shell through the aperture and the cover closed, the container may be grasped by the user to dig into the ground surface and then be buried below the ground surface. A marker strap is fixed to the shell, such that the marker strap may protrude from the ground surface to mark the location of the buried container. The hollow shell includes a pair of finger apertures for facilitating gripping of the container. The hollow shell further includes a plurality of divider slots and divider panels to divide the container into compartments, allowing the user to organize personal items within the container.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to storage containers, and more particularly to a container that may also be used as a digging implement.

### DISCUSSION OF RELATED ART

Individual safe containers for the beach are well known in the art. For example, U.S. Pat. No. 4,664,041 to Wood on May 12, 1987, teaches such a device. Such devices are made to protect personal items from being taken while enjoying the beach. However, despite the development of many approaches to beach safe containers, these approaches often have significant drawbacks.

A common approach to protecting personal items is to create a container that can be secured to the ground. The following patents all teach such a device: U.S. Pat. No. 4,454,824 to Wood on Jun. 19, 1984; U.S. Pat. No. 4,664,041 to Wood on May 12, 1987; U.S. Pat. No. 5,199,361 to Robinson on Apr. 6, 1993; and US Patent Application 2003/0051646 A1 to Cinquegrano on Mar. 20, 2003. These devices teach using a corkscrew type rod that passes through a hole in the bottom of the container and is drilled into the sand. The corkscrew rod pushes the bottom of the container towards the ground and prevents the container from being lifted. Once the cover on theses containers is closed and secured, then access to the corkscrew rod is blocked and opening and removal of the container becomes very difficult.

However, these devices have many drawbacks. They tend to be designed as large containers that would be used by multiple people and are not convenient for an individual to carry. Also, they require a ground surface that is sufficiently dense to secure the rod and would be difficult to use in very loose or shallow sand. Finally, the greatest drawback to these devices is that they are designed to be used above ground and are highly visible. Therefore a container device is needed that would be easy to carry by one person, would be usable in loose or shallow sand, and would be easily buried to reduce the visibility of the device and to avoid tempting potential thieves.

As the needed personal storage device is to be used at the beach, the device would preferably be designed for digging in the sand. The following patents teach devices designed for digging in the sand and snow: U.S. Pat. No. 5,951,079 to Winskye on Sep. 14, 1999 teaches a sandbag shovel; U.S. Pat. No. 5,575,315 to Wengert on Nov. 19, 1996 teaches a device and method for filling a sandbag; and U.S. Pat. No. 6,113,168 to St. Jeor on Sep. 5, 2000 teaches a compact snow digging implement. However, none of these devices teach using the digging device as a storage device to be buried. Therefore, there is a need for a device that can effectively dig in the sand and still effectively contain personal items while buried under the sand. Such as a device would need to be designed to keep sand out of the container and hold personal items safely in the container.

Therefore, there is a need for a device that would be easy to carry by one person, would be usable in loose or shallow sand, and would be easily buried to reduce the visibility of the device. The needed device would further be effective digging in the sand and still effectively hold personal items inside and keep unwanted sand out. The present invention accomplishes these objectives.

### SUMMARY OF THE INVENTION

The present device is a container for holding personal items of a user below a ground surface. The container includes a substantially hollow shell with a front side, a rear side, and an inside surface. Both the front and rear sides taper to a pointed lower end. The shell includes an aperture at a top end thereof. A cover is selectively attachable to the top end of the shell to cover the aperture. With the personal items inserted into the hollow shell through the aperture and covered with the cover, the container may be grasped by the user to dig into the ground surface and then be buried below the ground surface.

The hollow shell further includes a pair of finger apertures traversing from the front side to the rear side thereof. The finger apertures define handles for facilitating gripping of the container when used to dig into the ground surface. In another embodiment, the hollow shell further includes a pair of finger depressions facilitating the gripping of the container.

The cover is pivotally attached to the top end of the shell with a hinge means and includes a mirror on an inside surface of the cover. A marker strap is fixed to the shell, such that the marker strap may protrude from the ground surface to mark the location of the buried container. In a further embodiment, the container includes at least one towel retaining means for retaining a towel. In one more embodiment, the hollow shell includes a plurality of container divider slots and a plurality of divider panels capturable by the container divider slots to divide the container into compartments. The compartments allow the user to organize personal items within the container.

The present invention is a beach safe container that is easy to carry by one person, usable in loose or shallow sand, and easily buried to reduce the visibility of the device. The invention is effective for digging in the sand and still effectively keeps personal items inside and unwanted sand out. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a front elevational view of the invention, illustrating finger apertures, a cover with a mirror, and a marker strap;

FIG. 2 is a side elevational view of the invention, illustrating a cover and a marker strap;

FIG. 3 is a front cross-sectional view of the invention, taken generally along lines 3-3 of FIG. 2, illustrating an inside surface;

FIG. 4A is a side cross-sectional view of the invention, taken generally along lines 4-4 of FIG. 1, illustrating a cover in an open state;

FIG. 4A is a side cross-sectional view of the invention, taken generally along lines 4-4 of FIG. 1, illustrating a cover in a closed state;

FIG. 5 is a top plan view of the invention, illustrating a marker strap securing knot;

FIG. 6 is a front elevational view of the invention, illustrating a container being inserted into a ground surface by a user;

FIG. 7 is a front elevational view of a divider panel;

FIG. 8 is a front cross-sectional view of the invention, taken generally along lines 3-3 of FIG. 2, illustrating container divider slots and compartments;

FIG. 9 is a top plan view of the invention illustrating a marker strap with a towel retaining means;

FIG. 10 is a partial view of a marker strap and towel retaining means, illustrating a towel being retained; and

FIG. 11 is front elevational view of the invention, illustrating finger depressions.

### DETAILED DESCRIPTION OF THE PREFERRED EMBODIMENT

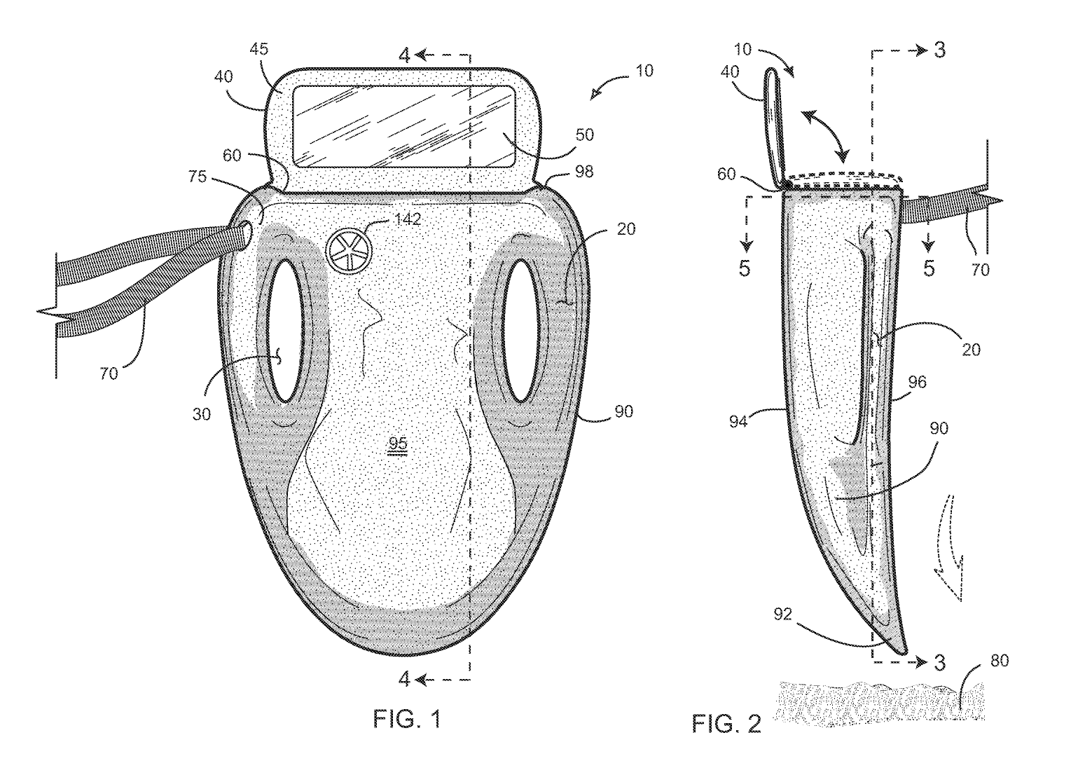

As illustrated in FIGS. 6 and 8, the present invention is a container 10 for holding personal items 15 of a user 130 below a ground surface 80. In FIGS. 2 and 4B, the container 10 includes a substantially hollow shell 90 with a front side 94, a rear side 96, and an inside surface 95. Both the front and rear sides 94,96 taper to a pointed lower end 92 (FIG. 2). In FIGS. 1 and 9, the shell 90 includes an aperture 48 at a top end 98 thereof. FIGS. 1 and 9 further illustrate a cover 40 is selectively attachable to the top end 98 of the shell 90 to cover the aperture 48. With the personal items 15 (FIG. 8) inserted into the hollow shell 90 through the aperture 48 and covered with the cover 40, the container 10 may be grasped by the user 130 to dig into the ground surface 80 and then be buried below the ground surface 80, as illustrated in FIGS. 6 and 8. The container 10 is preferably made primarily from a light weight and durable material such as a rigid plastic material, but can also be formed from any suitable rigid material, if desired. In a preferred embodiment illustrated in FIGS. 1 and 2, the hollow shell 90 further includes a pair of finger apertures 30 traversing from the front side 94 to the rear side 96 thereof. The finger apertures 30 define handles 20 for facilitating gripping of the container 10 when used to dig into the ground surface 80, illustrated in FIGS. 1 and 2. In another embodiment, the hollow shell 90 further includes a pair of finger depressions 35 (FIG. 11) facilitating the gripping of the container 10 when used to dig into the ground surface 80.

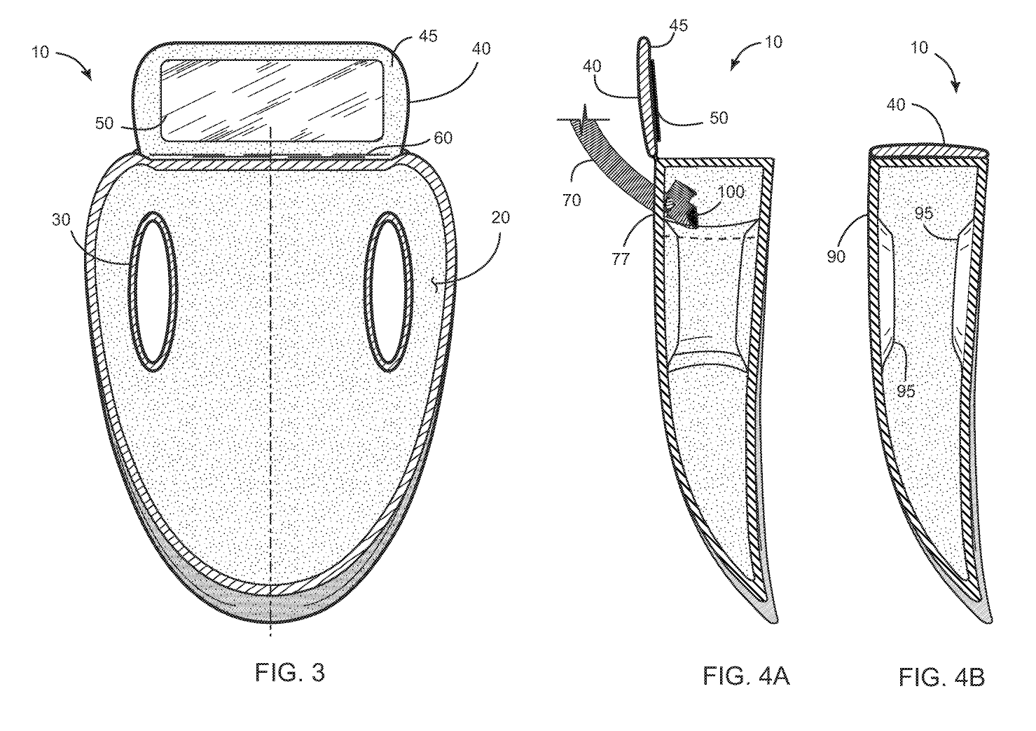

In FIGS. 1 and 2, the cover 40 is pivotally attached to the top end 98 of the shell 90 with a hinge means 60. In one embodiment, the hinge means 60 is a pin (not shown) that runs through holes in the cover 40 and the shell 90 thereby hingedly joining the cover 40 and shell 90 together. In a preferred embodiment, the hinge means 60 is a living hinge and the cover 40 is integrally formed with the hollow shell 90. In another embodiment, the cover 40 is frictionally engageable within the aperture 48 of the hollow shell 90. In one more embodiment illustrated in FIGS. 3 and 4A, the container 10 includes a mirror 50 on an inside surface 45 of the cover 40.

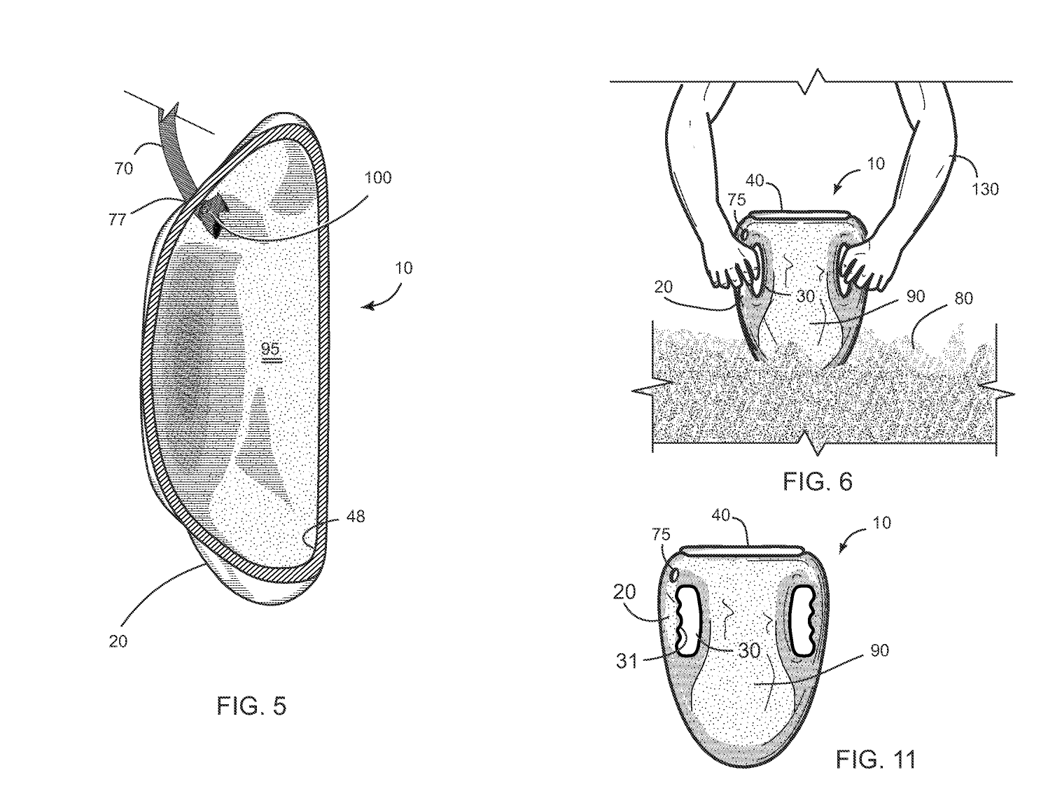

In the embodiment illustrated in FIG. 8, a marker strap 70 is fixed to the shell 90, such that the marker strap 70 may protrude from the ground surface 80 to mark the location of the buried container 10. In one embodiment illustrated in FIGS. 1 and 6, the shell 90 further includes a loop aperture 75 traversing from the front side 94 to the rear side 96 thereof, and through which the marker strap 70 can be looped to be attached to the container 10. In another embodiment illustrated in FIGS. 4A and 5, the shell 90 includes a knot aperture 77 through either the front side 94 or rear side 96. The marker strap 70 can be attached to the container 10 by passing the marker strap 70 through the knot aperture 77 and tying a securing knot 100 in the marker strap 70 inside the shell 90.

In an embodiment illustrated in FIGS. 9 and 10, the container 10 further includes at least one towel retaining means 140 for retaining a towel 150. In one embodiment illustrated in FIG. 1, the towel retaining means 140 is a clip 142 connected to either the front side 94 or rear side 96 of the shell 90. In another embodiment illustrated in FIGS. 9 and 10, the towel retaining means 140 is an aperture clip 144 attached at the end of the marker strap 70. The towel 150 is retained by being pushed through the aperture clip 144 and retained by friction.

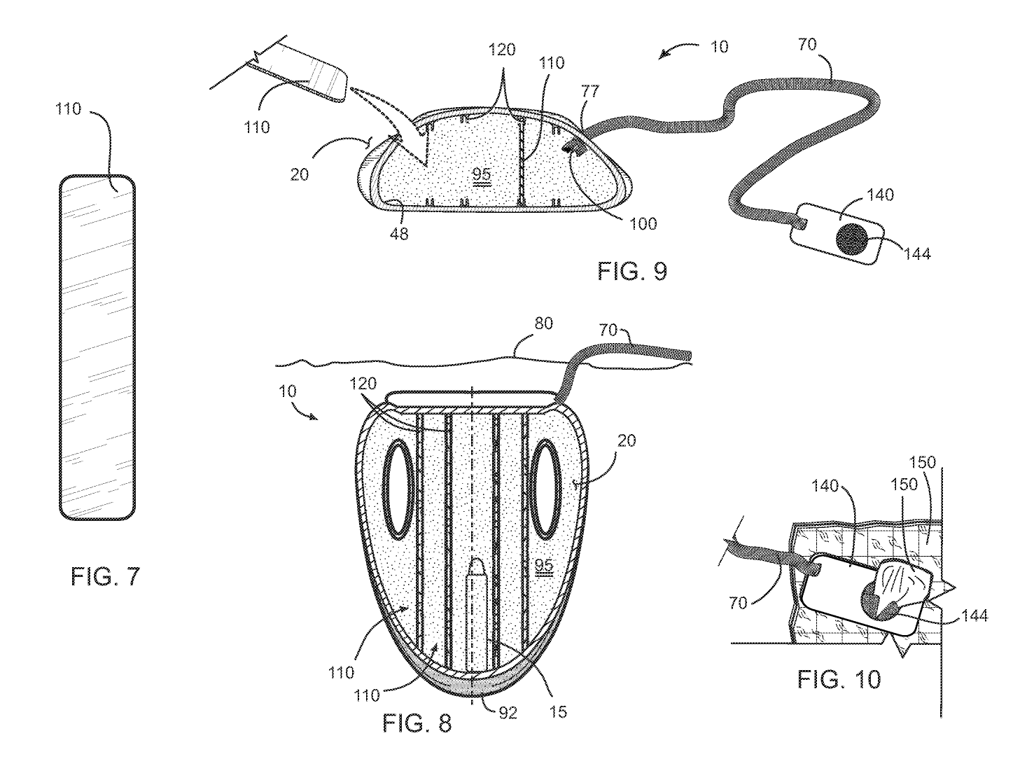

In one more embodiment illustrated in FIGS. 8 and 9, the hollow shell 90 includes a plurality of container divider slots 120. The container 10 further includes a plurality of divider panels 110 (FIG. 7) capturable by the container divider slots 120 to divide the container 10 into compartments 115. The compartments 115 allow the user 130 to organize personal items 15 within the container 10.

While a particular form of the invention has been illustrated and described, it will be apparent that various modifications can be made without departing from the spirit and scope of the invention. For example, the divider panels 140 could be designed specifically to accommodate the shape of a water bottle (not shown). Also the cover 40 could include a lock (not shown) to provide further security to the device. Accordingly, it is not intended that the invention be limited, except as by the appended claims.

What is claimed is:

1. A container for holding personal items of a user below a ground surface, comprising:
a substantially hollow shell having a front side and a rear side, both the front and rear sides tapering to a pointed lower end, the shell including an aperture at a top end thereof, and
a cover selectively attachable to the top end of the shell to cover the aperture;
whereby with the personal items inserted into the hollow shell through the aperture and covered with the cover, the container may be grasped by the user to dig into the ground surface and then buried below the ground surface.

2. The container of claim 1 wherein the hollow shell further includes a pair of finger apertures traversing from the front side to the rear side thereof, the finger apertures defining handles for facilitating gripping of the container when used to dig into the ground surface.

3. The container of claim 1 wherein the cover is pivotally attached to the top end of the shell with a hinge means.

4. The container of claim 3 wherein the hinge means is a living hinge and the cover is integrally formed with the hollow shell.

5. The container of claim 1 wherein the cover includes on an inside surface thereof a mirror.

6. The container of claim 1 further including a marker strap fixed to the shell, such that the marker strap may protrude from the ground surface to mark the location of the buried container.

7. The container of claim 1 wherein the hollow shell includes a plurality of container divider slots, and wherein the container further includes a plurality of divider panels capturable by the container divider slots to divide the container into compartments.

8. The container of claim 1 wherein the cover is frictionally engageable within the aperture of the hollow shell.

9. The container of claim 1 further including at least one towel retaining means.

10. The container of claim 1 wherein the hollow shell further includes a pair of finger depressions facilitating the gripping of the container when used to dig into the ground surface.
